(19) United States
(12) Patent Application Publication
(10) Pub. No.: US 2017/0341701 A1
(43) Pub. Date: Nov. 30, 2017

(54) AXIAL LOADING DEVICE HAVING A COVER FOR CONCEALING A LOAD IMPARTING FASTENER RECEIVING PORTION THEREOF AND BICYCLE HEADSET ASSEMBLY COMPRISING SAME

(71) Applicant: Philip Reed, Austin, TX (US)

(72) Inventor: Philip Reed, Austin, TX (US)

(21) Appl. No.: 15/212,232

(22) Filed: Jul. 16, 2016

Related U.S. Application Data
(63) Continuation-in-part of application No. 29/566,120, filed on May 26, 2016.

(51) Int. Cl. B62K 21/02

(52) U.S. Cl. CPC B62K 21/02

(57) ABSTRACT

Embodiments of the present invention are directed to a bicycle headset assembly. More specifically, such embodiments comprise a headset assembly cap having a cover that is mountable thereon. The cover serves at least two purposes. One purpose is to conceal a load imparting fastener receiving portion of the headset assembly cap. Another purpose is to provide a contiguous surface on which graphics can be provided.

### CROSS-REFERENCE TO RELATED APPLICATIONS

This continuation-in-part application claims priority from co-pending U.S. Design patent application having Ser. No. 29/566,120, filed 26-May 2016, entitled “BICYCLE HEADSET CAP WITH COVER”, having a common applicant herewith and being incorporated herein in its entirety by reference.

### FIELD OF THE DISCLOSURE

The disclosures made herein relate generally to apparatuses for imparting an axial load on a structural body engaged with a tubular support member and, more particularly, to an axial loading device having a cover for concealing a load imparting fastener receiving portion thereof. In one or more specific embodiments, such apparatus is implemented as a bicycle headset cap assembly.

### BACKGROUND

It is well known that a fork assembly of a bicycle is attached to a head tube (i.e., a tubular support member) of a bicycle frame through a plurality of bearing interfaces. For example, a steerer tube of the fork is generally mounted on the head tube through upper and lower bearing interfaces. A handlebar stem (i.e., a structural body) mounts on the steerer tube above the upper bearing interface and bears against the head tube through a bearing of the upper bearing interface for allowing a handlebar to be coupled to the fork in a manner that provides for allowing concerted rotation of the fork and handlebar. Typically, the upper and lower bearing interfaces each include a bearing and one or more bearing races that are jointly configured to allow for rotation of the steer tube with respect to the head tube and to positively locate the steerer tube radially and axially with respect to the head tube. The steerer tube and the head tube are examples of concentrically arranged tubes.

It is also well known that the failure to maintain an adequate preload between each one of the bearing interfaces can lead to one or more adverse situation. One such adverse situation is damage or premature wear of the bearing and/or one or more races due to excessive or inadequate preload. Another such adverse situation is unpredictable steering of the bicycle fork due to inadequate preload that leads to radial movement of the steerer tube with respect to the head tube (i.e., the frame). Still another such adverse situation is unpredictable steering of the bicycle fork due to excessive preload that inhibits smooth, effortless and controlled rotational movement of the steerer tube with respect to the head tube.

A bicycle headset assembly is well known to be used to provide a preload force on the bearing interfaces. A cap of the headset assembly (i.e., an axial loading device) sits on an upper face of the handlebar stem. A load imparting fastener, which extends through and is seated on the headset assembly cap, engages a mount with the steerer tube within its central passage. Sufficient tightening of the load imparting fastener results in the generation of a preload force being exerted on the bearing interfaces through the handlebar stem and headset assembly cap.

In a conventional bicycle headset assembly, a head portion of the load imparting fastener is visibly exposed at the upper surface of the headset assembly cap. In this respect, some users consider the exposed head of the load imparting fastener and the corresponding load imparting fastener receiving portion of the headset assembly cap to hinder aesthetic appeal. Thus, an axial loading device having a cover for concealing a load imparting fastener receiving portion thereof and that is specifically configured for imparting a preload on bearing interfaces coupling concentrically arranged tubes (or other structural assembly) would be advantageous, desirable and useful.

### SUMMARY OF THE DISCLOSURE

One or more embodiments of the present invention are directed to a bicycle headset assembly. More specifically, such embodiments comprise a headset assembly cap having a cover that is mountable thereon. The cover serves at least two purposes. One purpose is to conceal a load imparting fastener receiving portion of the headset assembly cap. Another purpose is to provide a contiguous surface on which graphics can be provided. In this respect the headset assembly cap and the cover jointly define a bicycle headset cap assembly that is advantageous, desirable and useful.

In one embodiment of the present invention, an apparatus for engaging concentrically-arranged tubular members comprises a cap and a cover. The cap has a circular-shaped perimeter edge portion, an upper surface and a lower surface. A central passage extends through the cap between the upper surface and the lower surface. The central passage includes a fastener head receiving space at the upper surface. The cover has a round top wall and at least one retention lip extending downwardly from a perimeter edge portion of the top wall. The at least one retention lip is adapted for engaging a mating portion of the perimeter edge portion of the cap for securing the cover to the cap. The top wall adjacent to the at least one retention lip is upwardly contoured. The top wall is flexible thereby causing outward deflection of the at least one retention lip when the top wall is deflected in a downward direction.

In another embodiment of the present invention, a bicycle headset assembly comprises a headset assembly cap and a cover mounted on the headset assembly cap. The headset assembly cap has an upper surface and a lower surface. The lower surface includes a shoulder adapted to be engaged with a top edge of a tubular mount of a handlebar stem. A central passage extends through the headset assembly cap between the upper surface and the lower surface. The central passage includes a fastener head receiving space at the upper surface. A portion of the upper surface that encompasses the central passage is downwardly contoured with respect to a perimeter edge portion of the headset assembly cap. A retention lip portion of the cover is engaged with a mating portion of the headset assembly cap for securing the cover to the headset assembly cap. A top wall of the cover is upwardly contoured such that a space between the top wall of the cover and the upper surface of the headset assembly cap is greater adjacent to the fastener head receiving space than adjacent to the retention lip portion of the cover. The top wall is adapted to be downwardly deflected thereby causing outward deflection of the retention lip portion to aid in at least one of detachment of the cover from the headset assembly cap and rotation of the cover with respect to the headset assembly cap.

In another embodiment of the present invention, a bicycle headset kit comprises a headset assembly cap and a cover. The headset assembly cap has an upper surface and a lower surface. The lower surface includes a shoulder adapted to be engaged with a top edge of a tubular mount of a handlebar stem. A central passage extends through the cap between the upper surface and the lower surface. The central passage includes a fastener head receiving space at the upper surface. A portion of the upper surface that encompasses the central passage is downwardly contoured with respect to a perimeter edge portion of the cap. The cover has a retention lip portion adapted to be engaged with a mating portion of the cap for securing the cover to the cap. The top wall is upwardly contoured with respect to a bottom edge of the retention lip portion. The top wall is adapted to be downwardly deflected thereby causing outward deflection of the retention lip portion to aid in at least one of engagement of the retention lip portion with a mating portion of the headset assembly cap, detachment of the cover from the headset assembly cap and rotation of the cover with respect to the headset assembly cap.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a first perspective view showing bicycle headset assembly in accordance with a first embodiment of the present invention;

FIG. 2 is a second perspective view showing the bicycle headset assembly shown in FIG. 1

FIG. 3 is a cross-sectional view taken along the line 3-3 in FIG. 2;

FIG. 4 is a cross-sectional view of a cover of the bicycle headset assembly shown in FIG. 1;

FIG. 5 is a cross-sectional view of a headset assembly cap of the bicycle headset assembly shown in FIG. 1;

FIG. 6 is a perspective view a showing a bottom of the cover of the bicycle headset assembly shown in FIG. 1;

FIG. 7 is a cross sectional view showing a bicycle headset assembly in accordance with a second embodiment of the present invention;

FIG. 8 is a perspective view of a cap of the bicycle headset assembly shown in FIG. 7; and

FIG. 9 is a perspective view of a cover of the bicycle headset assembly shown in FIG. 7.

### DETAILED DESCRIPTION

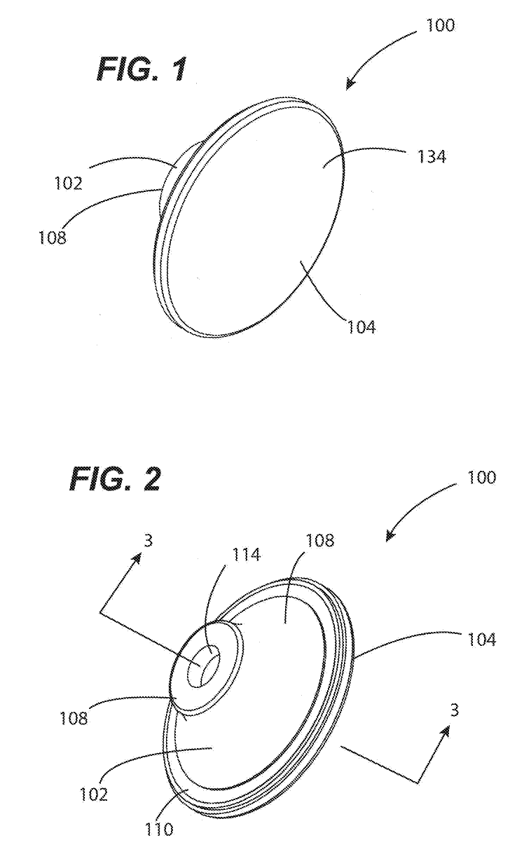

Referring to FIGS. 1-3, a bicycle headset assembly 100 is shown. The bicycle headset assembly 100 includes a headset assembly cap 102 and a cover 104 mounted on the headset assembly cap 102. The headset assembly cap 102 has an upper surface 106 and a lower surface 108. The lower surface 108 includes a shoulder 110 adapted to be engaged with a top edge of a tubular mount 112 of a handlebar stem 113. A central passage 114 extends through the headset assembly cap 102 between the upper surface 106 and the lower surface 108. The central passage 114 includes a fastener head receiving space 116 at the upper surface 106 of the headset assembly cap 102 that is adapted to receive a head portion 118 of a fastener 120 (e.g., threaded bolt). A shank portion 122 of the fastener 120 engages a mount 123 within a steerer tube 124 of a fork that extends through (e.g., concentrically though) a head tube 119 of a bicycle frame into engagement the tubular mount 112 of a handlebar stem 113. The fork steerer tube 124 is coupled to the had tube 119 through an upper and lower bearing interface (not shown). In use, the headset assembly cap 102 and the fastener 120 jointly provide for preloading of the upper and lower bearing interface by tightening of the fastener 120 (i.e., the fastener urging the headset assembly cap 102 toward the mount 123 within the fork steerer tube 124 and correspondingly urging a crown portion of the fork toward a lower portion of the head tube 119).

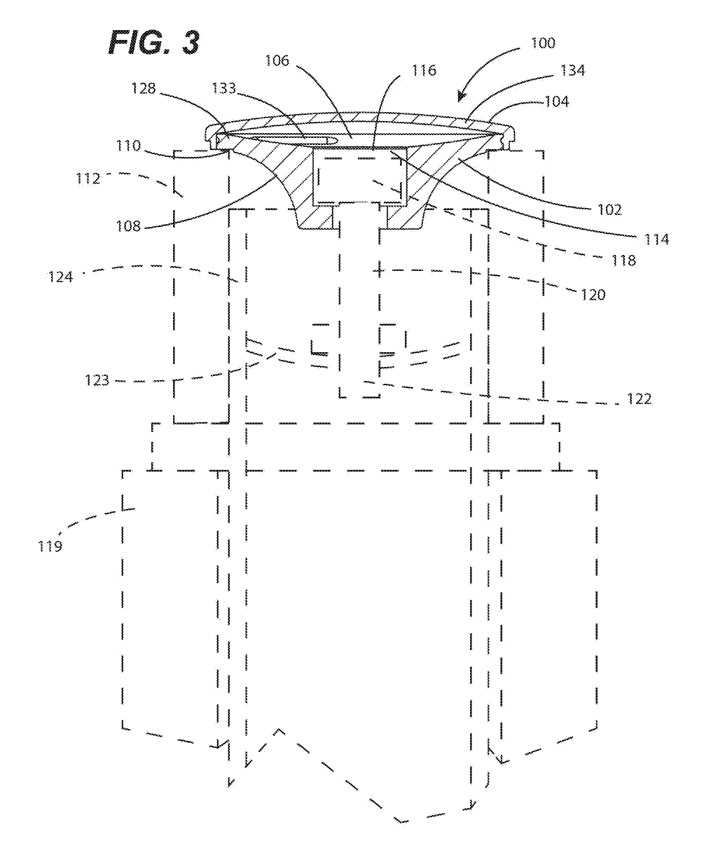

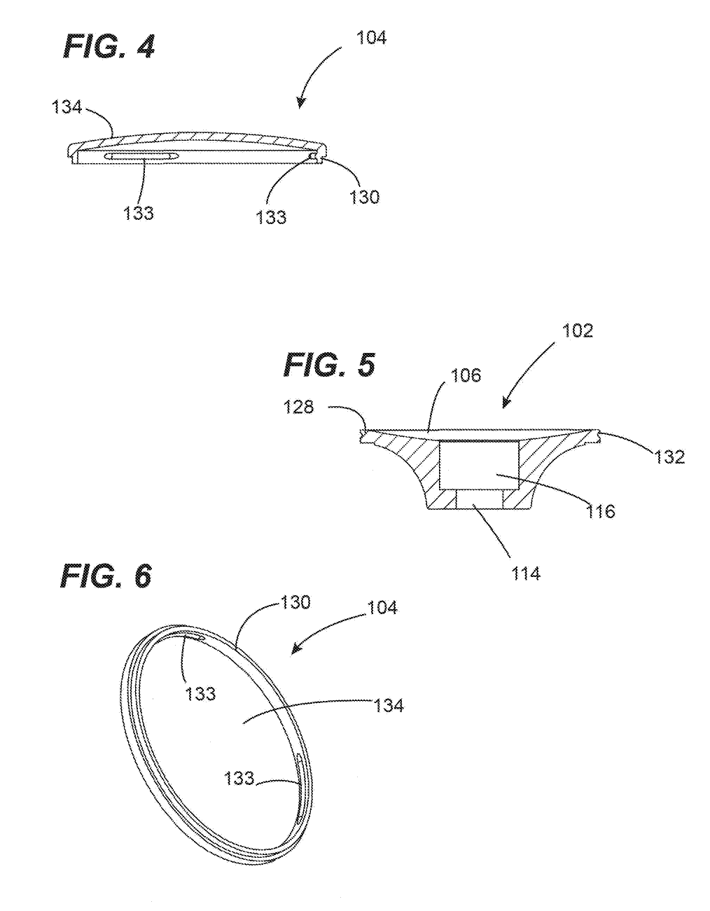

As best shown in FIGS. 3-5, the upper surface 106 is concave (i.e., downwardly contoured with respect to a perimeter edge portion 128 of the headset assembly cap 102). Although, as shown, an entire portion of the upper surface 106 is concave, it is disclosed herein that only a portion of the upper surface that surrounds the central passage 116 can be downwardly contoured (e.g., concave shaped). A retention lip portion 130 of the cover 104 is engaged with a groove 132 (i.e., a mating retention feature) in an exterior edge surface of the headset assembly cap 102 for securing the cover 104 to the headset assembly cap 102. For example, as shown, the retention lip portion 130 may include one or more retention ridges 133 thereon (i.e., retention features) that are adapted for being engaged with the groove 132 of the headset assembly cap 102.

A top wall 134 of the cover 104 is upwardly contoured (e.g., convex shaped) such that a space between the top wall 134 of the cover 104 and the upper surface 106 of the headset assembly cap 102 is greater adjacent to the fastener head receiving space 116 than adjacent to the retention lip portion 130 of the cover 104. As best shown in FIG. 6, preferably, the top wall 134 is substantially round and the retention lip portion 130 extends contiguously around an entire portion of the top wall 134 with a plurality of ridges 133 spaces along a length of the retention lip portion 130. Alternatively, a plurality of discrete retention lip portions may be spaced around the circumference of the top wall 134 with a plurality of the discrete retention lip portions including a respective retention feature (e.g., ridge) for engaging the mating retention feature of the headset assembly cap 102 (e.g., the groove 132). Advantageously, the cover 104 of the bicycle headset assembly 100 serves to conceal a load imparting fastener receiving portion of the headset assembly cap and to provide a contiguous surface on which graphics can be provided.

The top wall 134 is adapted to be downwardly deflected thereby causing outward deflection (e.g., slight yet appreciable deflection) of the retention lip portion 130 to aid in detachment of the cover 104 from the headset assembly cap 102, detachment of the cover 104 from the headset assembly cap 102, rotation of the cover 104 with respect to the headset assembly cap 102 or a combination thereof. For example, the top wall 134 can be made from a material that is flexible and/or can be otherwise configured (e.g., having a thickness) that allows the top wall 134 to be manually flexed by a finger of a user.

Preferred embodiments of the present invention are directed to a bicycle headset assembly. Such a bicycle headset assembly is an example of an apparatus for engaging concentrically-arranged tubular members. As disclosed herein the components of a bicycle headset assembly can be offered in the form of a bicycle headset kit. Such a bicycle headset kit includes a headset assembly cap and cover in accordance with an embodiment of the present invention.

The headset assembly cap 102 and cover 104 can be made from known and conventional material using known and conventional methods of manufacture. In some embodiments, the headset assembly cap 102 is preferably made from a metallic material by a process such as, for example, CNC (computer numeric machining). In some embodiments, the cover 104 is preferably made from a polymeric material by a process such as, for example, injection molding CNC machining, 3-D printing or the like.

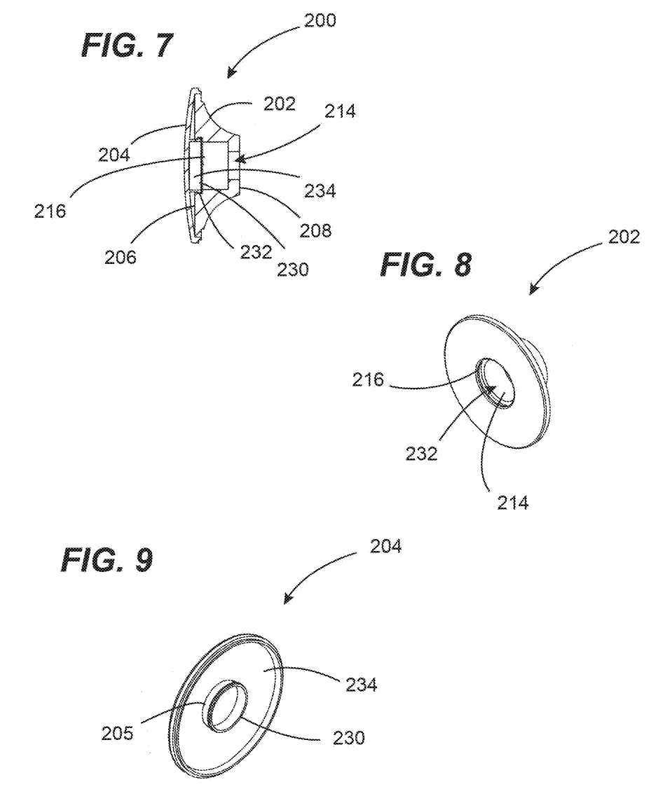

Referring now to FIG. 7, a bicycle headset assembly 200 in accordance with a second embodiment of the present invention is shown. The bicycle headset assembly 200 provides the same underlying functionality on a bicycle as the bicycle headset assembly 100 discussed above in reference to FIGS. 1-6. Although the as-assembled configuration of the bicycle headset assembly 200 is the same as the bicycle headset assembly 100 discussed above in reference to FIGS. 1-6, the manner in which a headset assembly cap 202 (FIG. 8) of the headset assembly 200 is engaged with a cover 204 (FIG. 9) of the headset assembly 200 is substantially different than that of the bicycle headset assembly 100 discussed above in reference to FIGS. 1-6.

The cover 204 includes a retention portion 205 that extends from a rear face of a top wall 234 thereof. As shown in FIGS. 7 and 8, a central passage 214 extends through the headset assembly cap 202 between an upper surface 206 and a lower surface 108 thereof. The central passage 214 includes a fastener head receiving space 216 at the upper surface 206 of the headset assembly cap 202. The retention portion 205 of the cover 204 includes a retention lip portion 230 that is engaged with a groove 232 (i.e., a mating retention feature) in a surface of the headset assembly cap 102 that defines the fastener head receiving space 216. In this manner, engagement of the retention lip portion 230 with the groove 232 secures the cover 204 to the headset assembly cap 202.

In yet another embodiment (not specifically shown), it is disclosed herein that the retention portion 205 of the cover 204 can be configured to engage a mating portion of a head of a threaded fastener seated within the fastener head receiving space 216 of the headset assembly cap 202 rather than being engaged with the groove 232.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. An apparatus for engaging concentrically-arranged tubular members, comprising:
a cap having a circular-shaped perimeter edge portion, an upper surface and a lower surface, wherein a central passage extends through the cap between the upper surface and the lower surface, wherein the central passage includes a fastener head receiving space at the upper surface; and
a cover having a round top wall and at least one retention lip extending downwardly from a perimeter edge portion of the top wall, wherein the at least one retention lip is adapted for engaging a mating portion of the perimeter edge portion of the cap for securing the cover to the cap, wherein the top wall adjacent to the at least one retention lip is upwardly contoured and wherein the top wall is flexible thereby causing outward deflection of the at least one retention lip when the top wall in deflected in a downward direction.

2. The apparatus of claim 1 wherein a portion of the upper surface that encompasses the central passage is downwardly contoured with respect to the perimeter edge portion of the cap.

3. The apparatus of claim 1 wherein an entire portion of the upper surface that encompasses the central passage is downwardly contoured with respect to the perimeter edge portion of the cap.

4. The apparatus of claim 3 wherein the upper surface is concave.

5. The apparatus of claim 1 wherein:
the top wall is substantially round; and
the at least one retention lip extends contiguously around an entire portion of the top wall.

6. The apparatus of claim 1 wherein:
an exterior side surface of the cap at the perimeter edge portion thereof has a retention depression therein; and
the at least one retention lip includes at least one retention ridge thereon that is adapted for being engaged with the retention depression therein.

7. The apparatus of claim 6 wherein:
the top wall is substantially round; and
the at least one retention lip comprises a retention lip that extends contiguously around an entire portion of the top wall.

8. The apparatus of claim 7 wherein an entire portion of the upper surface that encompasses the central passage is downwardly contoured with respect to the perimeter edge portion of the cap.

9. The apparatus of claim 8 wherein the retention lip comprises a plurality of retention ridges spaced apart from each other along a length of the retention lip.

10. The apparatus of claim 7 wherein the retention lip comprises a plurality of retention ridges spaced apart from each other along a length of the retention lip.

11. A bicycle headset assembly, comprising:
a headset assembly cap having an upper surface and a lower surface, wherein the lower surface includes a shoulder adapted to be engaged with a top edge of a tubular mount of a handlebar stem, wherein a central passage extends through the headset assembly cap between the upper surface and the lower surface, wherein the central passage includes a fastener head receiving space at the upper surface and wherein a portion of the upper surface that encompasses the central passage is downwardly contoured with respect to a perimeter edge portion of the headset assembly cap; and
a cover mounted on the headset assembly cap, wherein a retention lip portion of the cover is engaged with a mating portion of the headset assembly cap for securing the cover to the headset assembly cap, wherein a top wall of the cover is upwardly contoured such that a space between the top wall of the cover and the upper surface of the headset assembly cap is greater adjacent to the fastener head receiving space than adjacent to the retention lip portion of the cover and wherein the top wall is adapted to be downwardly deflected thereby causing outward deflection of the retention lip portion to aid in at least one of detachment of the cover from the headset assembly cap and rotation of the cover with respect to the headset assembly cap.

12. The bicycle headset assembly of claim 11 wherein an entire portion of the upper surface that encompasses the central passage is downwardly contoured with respect to the perimeter edge portion of the headset assembly cap.

13. The bicycle headset assembly of claim 12 wherein the upper surface is concave.

14. The bicycle headset assembly of claim 11 wherein:
the top wall is substantially round; and
the retention lip portion of the headset assembly cap extends contiguously around an entire portion of the top wall.

15. The bicycle headset assembly of claim 11 wherein:
an exterior side surface of the headset assembly cap at the perimeter edge portion thereof has a retention depression therein; and
the retention lip portion of the headset assembly cap includes at least one retention ridge thereon that is adapted for being engaged with the retention depression therein.

16. The bicycle headset assembly of claim 15 wherein
the top wall is substantially round;
the retention lip portion of the headset assembly cap comprises a retention lip that extends contiguously around an entire portion of the top wall; and
the retention lip comprises a plurality of retention ridges spaced apart from each other along a length of the retention lip.

17. A bicycle headset kit, comprising:
a headset assembly cap having an upper surface and a lower surface, wherein the lower surface includes a shoulder adapted to be engaged with a top edge of a tubular mount of a handlebar stem, wherein a central passage extends through the cap between the upper surface and the lower surface, wherein the central passage includes a fastener head receiving space at the upper surface and wherein a portion of the upper surface that encompasses the central passage is downwardly contoured with respect to a perimeter edge portion of the cap; and
a cover having a retention lip portion adapted to be engaged with a mating portion of the cap for securing the cover to the cap, wherein the top wall is upwardly contoured with respect to a bottom edge of the retention lip portion and wherein the top wall is adapted to be downwardly deflected thereby causing outward deflection of the retention lip portion to aid in at least one of engagement of the retention lip portion with a mating portion of the headset assembly cap, detachment of the cover from the headset assembly cap and rotation of the cover with respect to the headset assembly cap.

18. The bicycle headset kit of claim 17 wherein an entire portion of the upper surface that encompasses the central passage is downwardly contoured with respect to the perimeter edge portion of the headset assembly cap.

19. The bicycle headset kit of claim 17 wherein:
the top wall is substantially round; and
the retention lip portion of the headset assembly cap extends contiguously around an entire portion of the top wall.

20. The bicycle headset kit of claim 17 wherein:
an exterior side surface of the headset assembly cap at the perimeter edge portion thereof has a retention feature therein;
the retention lip portion of the headset assembly cap includes at least one retention ridge thereon that is adapted for being engaged with the retention feature therein;
the top wall is substantially round;
the retention lip portion of the headset assembly cap comprises a retention lip that extends contiguously around an entire portion of the top wall; and
the retention lip comprises a plurality of retention ridges spaced apart from each other along a length of the retention lip.
